(19) United States
(12) Patent Application Publication
(10) Pub. No.: US 2022/0051661 A1
(43) Pub. Date: Feb. 17, 2022

(54) ELECTRONIC DEVICE PROVIDING MODIFIED UTTERANCE TEXT AND OPERATION METHOD THEREFOR

(71) Applicant: Samsung Electronics Co., Ltd., Suwon-si, Gyeonggi-do (KR)

(72) Inventors: Sangmin PARK, Suwon-si (KR); Gajin SONG, Suwon-si (KR)

(21) Appl. No.: 17/279,284

(22) PCT Filed: Oct. 14, 2019
(86) PCT No.: PCT/KR2019/013443

§ 371 Date: Mar. 24, 2021

(30) Foreign Application Priority Data
Oct. 15, 2018 (KR) 10-2018-0122313

(51) Int. Cl. G10L 15/16; G10L 25/72; G06N 3/04; H04L 29/08

(52) U.S. Cl. CPC G10L 15/16; H04L 67/12; G06N 3/0454; G10L 25/72

(57) ABSTRACT

Disclosed is an operation method of an electronic device that communicates with a server including receiving a domain and a category, transmitting the domain and the category to the server, receiving a modified utterance text corresponding to the domain and the category from the server, and displaying the modified utterance text. The modified utterance text is generated through a generation model or a transfer learning model based on user utterance data stored in advance in the server. The server is configured to convert voice data, which is delivered to the server by an external electronic device receiving a user utterance, into a text and to store the text as the user utterance data. Besides, various embodiments as understood from the specification are also possible.

### TECHNICAL FIELD

Embodiments disclosed in this specification relate to a technology for providing a modified utterance text corresponding to a training utterance text.

### BACKGROUND ART

In addition to a conventional input scheme using a keyboard or a mouse, electronic devices may support various input schemes such as a voice input and the like, nowadays. For example, the electronic devices such as a smartphone or a tablet PC may recognize a user's voice entered while a speech recognition service is executed and then may execute an operation corresponding to a voice input or may provide search results.

Nowadays, the speech recognition service is being developed based on a technology for processing a natural language. The technology for processing the natural language refers to a technology that grasps the intent of a user utterance and provides the user with the result matched with the intent.

### DISCLOSURE

### Technical Problem

A server providing a speech recognition service is trained based on a training utterance text set manually written by a developer. The developer generates a representative utterance, generates an application utterance for the representative utterance, and writes a training utterance text set. Accordingly, a training effect by the training utterance text set depends on the developer's ability.

Various embodiments of the disclosure are to provide a method of generating an additional modified utterance text set in a server for training of a speech recognition service based on a training utterance text set or an actual user utterance.

In addition, various embodiments of the disclosure are to provide a method of providing a developer or a user with the modified utterance text set that is generated.

### Technical Solution

According to an embodiment disclosed in this specification, an operation method of an electronic device that communicates with a server includes receiving a domain and a category, transmitting the domain and the category to the server, receiving a modified utterance text corresponding to the domain and the category from the server, and displaying the modified utterance text. The modified utterance text is generated through a generation model or a transfer learning model based on user utterance data stored in advance in the server. The server is configured to convert voice data, which is delivered to the server by an external electronic device receiving a user utterance, into a text and to store the text as the user utterance data.

Furthermore, according to an embodiment disclosed in this specification, an operation method of an electronic device that communicates with a server includes receiving a domain and a category, receiving a training utterance text set corresponding to the domain and the category, transmitting the domain, the category, and the training utterance text set to the server, receiving a modified utterance text set corresponding to the training utterance text set from the server, and displaying the modified utterance text set. The modified utterance text set is generated through a generation model or a transfer learning model based on user utterance data stored in advance in the server. The server is configured to convert voice data, which is delivered to the server by an external electronic device receiving a user utterance, into a text and to store the text as the user utterance data.

Moreover, according to an embodiment disclosed in this specification, an operation method of an electronic device that communicates with a server includes receiving a domain and a category, receiving a training utterance text set corresponding to the domain and the category, transmitting the domain, the category, and the training utterance text set to the server, receiving a modified utterance text set corresponding to the training utterance text set from the server, and displaying a plurality of second parameters corresponding to a first parameter included in the training utterance text set based on the modified utterance text set.

### Advantageous Effects

According to embodiments disclosed in this specification, it is possible to generate a modified utterance text set based on user utterance data that has been accumulated in the past.

According to embodiments disclosed in this specification, it is possible to generate a modified utterance text set based on a generation model or a transfer learning model.

According to embodiments disclosed in this specification, it is possible to generate a modified utterance text set based on a user feature.

According to embodiments disclosed in this specification, it is possible to train a natural language understanding module of a server based on the generated modified utterance text set.

According to embodiments disclosed in this specification, it is possible to improve the performance of a speech recognition service by recommending the modified utterance text set, which is generated, to a developer or a user.

Besides, a variety of effects directly or indirectly understood through the specification may be provided.

### DESCRIPTION OF DRAWINGS

FIG. 1 is a block diagram illustrating an integrated intelligence system, according to an embodiment.

FIG. 2 is a diagram illustrating the form in which relationship information between a concept and an action is stored in a database, according to an embodiment.

FIG. 3 is a view illustrating a user terminal displaying a screen of processing a voice input received through an intelligence app, according to an embodiment.

FIG. 4 is a block diagram illustrating an intelligence server generating a modified utterance text set according to an embodiment.

FIG. 5 is a block diagram illustrating an embodiment of the parameter collection module of FIG. 4.

FIG. 6 is a flowchart illustrating a method of operating an intelligence server in an NLU training mode according to an embodiment.

FIG. 7 is a flowchart illustrating an example of a method of generating a modified utterance text set in operation 650 of FIG. 6.

FIG. 8 is a flowchart illustrating another example of a method of generating a modified utterance text set in operation 650 of FIG. 6.

FIG. 9 is a flowchart illustrating an operation method of an intelligence server in an utterance recommendation mode according to an embodiment.

FIG. 10A is a diagram illustrating a method of recommending a modified utterance text depending on a category of a domain entered when a training utterance text is entered through an utterance input device, according to an embodiment.

FIG. 10B is a diagram illustrating a method of recommending a modified utterance text depending on intent of a user utterance example entered when a training utterance text is entered through an utterance input device, according to an embodiment.

FIG. 10C is a diagram illustrating a method of recommending modified utterance text depending on a keyword included in a user utterance example entered when a training utterance text is entered through an utterance input device, according to an embodiment.

FIG. 11 is a diagram illustrating a method of recommending a modified utterance text to a user during a user utterance, according to an embodiment.

FIG. 12 is a block diagram illustrating an electronic device in a network environment according to various embodiments.

With regard to description of drawings, the same or similar components will be marked by the same or similar reference signs.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

Prior to describing an embodiment of the disclosure, an integrated intelligence system to which an embodiment of the disclosure is capable of being applied will be described.

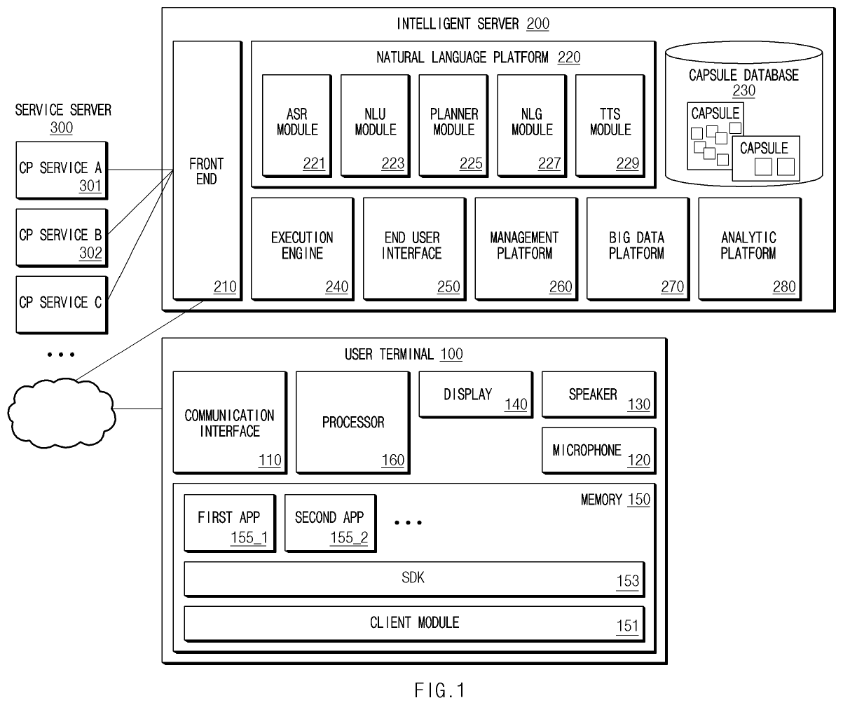

FIG. 1 is a block diagram illustrating an integrated intelligence system, according to an embodiment.

Referring to FIG. 1, an integrated intelligence system according to an embodiment may include a user terminal 100, an intelligence server 200, and a service server 300.

The user terminal 100 according to an embodiment may be a terminal device (or an electronic device) capable of connecting to Internet, and may be, for example, a mobile phone, a smartphone, a personal digital assistant (PDA), a notebook computer, TV, a white household appliance, a wearable device, a HMD, or a smart speaker.

According to the illustrated embodiment, the user terminal 100 may include a communication interface 110, a microphone 120, a speaker 130, a display 140, a memory 150, or a processor 160. The listed components may be operatively or electrically connected to one another.

The communication interface 110 according to an embodiment may be connected to an external device and may be configured to transmit or receive data to or from the external device. The microphone 120 according to an embodiment may receive a sound (e.g., a user utterance) to convert the sound into an electrical signal. The speaker 130 according to an embodiment may output the electrical signal as a sound (e.g., voice). The display 140 according to an embodiment may be configured to display an image or a video. The display 140 according to an embodiment may display the graphic user interface (GUI) of the running app (or an application program).

The memory 150 according to an embodiment may store a client module 151, a software development kit (SDK) 153, and a plurality of apps 155. The client module 151 and the SDK 153 may constitute a framework (or a solution program) for performing general-purposed functions. Furthermore, the client module 151 or the SDK 153 may constitute the framework for processing a voice input.

According to an embodiment, the plurality of apps 155 may be programs for performing a specified function. According to an embodiment, the plurality of apps 155 may include a first app 155_1 and a second app 155_2. According to an embodiment, each of the plurality of apps 155 may include a plurality of actions for performing a specified function. For example, the plurality of apps 155 may include an alarm app, a message app, and/or a schedule app. According to an embodiment, the plurality of apps 155 may be executed by the processor 160 to sequentially execute at least part of the plurality of actions.

According to an embodiment, the processor 160 may control overall operations of the user terminal 100. For example, the processor 160 may be electrically connected to the communication interface 110, the microphone 120, the speaker 130, and the display 140 to perform a specified operation.

Moreover, the processor 160 according to an embodiment may execute the program stored in the memory 150 to perform a specified function. For example, according to an embodiment, the processor 160 may execute at least one of the client module 151 or the SDK 153 to perform a following operation for processing a voice input. The processor 160 may control operations of the plurality of apps 155 via the SDK 153. The following operation described as an operation of the client module 151 or the SDK 153 may be executed by the processor 160.

According to an embodiment, the client module 151 may receive a voice input. For example, the client module 151 may receive a voice signal corresponding to a user utterance detected through the microphone 120. The client module 151 may transmit the received voice input to the intelligence server 200. The client module 151 may transmit state information of the user terminal 100 to the intelligence server 200 together with the received voice input. For example, the state information may be execution state information of an app.

According to an embodiment, the client module 151 may receive a result corresponding to the received voice input. For example, when the intelligence server 200 is capable of calculating the result corresponding to the received voice input, the client module 151 may receive the result corresponding to the received voice input. The client module 151 may display the received result on the display 140.

According to an embodiment, the client module 151 may receive a plan corresponding to the received voice input. The client module 151 may display, on the display 140, a result of executing a plurality of actions of an app depending on the plan. For example, the client module 151 may sequentially display the result of executing the plurality of actions on a display. For another example, the user terminal 100 may display only a part of results (e.g., a result of the last action) of executing the plurality of actions, on the display.

According to an embodiment, the client module 151 may receive a request for obtaining information necessary to calculate the result corresponding to a voice input, from the intelligence server 200. According to an embodiment, the client module 151 may transmit the necessary information to the intelligence server 200 in response to the request.

According to an embodiment, the client module 151 may transmit, to the intelligence server 200, information about the result of executing a plurality of actions depending on the plan. The intelligence server 200 may identify that the received voice input is correctly processed, using the result information.

According to an embodiment, the client module 151 may include a speech recognition module. According to an embodiment, the client module 151 may recognize a voice input for performing a limited function, via the speech recognition module. For example, the client module 151 may launch an intelligence app that processes a voice input for performing an organic action, via a specified input (e.g., wake up!).

According to an embodiment, the intelligence server 200 may receive information associated with a user's voice input from the user terminal 100 over a communication network. According to an embodiment, the intelligence server 200 may convert data associated with the received voice input to text data. According to an embodiment, the intelligence server 200 may generate a plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) or a recurrent neural network (RNN)). Alternatively, the AI system may be a combination of the above-described systems or an AI system different from the above-described system. According to an embodiment, the plan may be selected from a set of predefined plans or may be generated in real time in response to a user request. For example, the AI system may select at least one plan of the plurality of predefined plans.

According to an embodiment, the intelligence server 200 may transmit a result according to the generated plan to the user terminal 100 or may transmit the generated plan to the user terminal 100. According to an embodiment, the user terminal 100 may display the result according to the plan, on a display. According to an embodiment, the user terminal 100 may display a result of executing the action according to the plan, on the display.

The intelligence server 200 according to an embodiment may include a front end 210, a natural language platform 220, a capsule database (DB) 230, an execution engine 240, an end user interface 250, a management platform 260, a big data platform 270, or an analytic platform 280.

According to an embodiment, the front end 210 may receive a voice input received from the user terminal 100. The front end 210 may transmit a response corresponding to the voice input.

According to an embodiment, the natural language platform 220 may include an automatic speech recognition (ASR) module 221, a natural language understanding (NLU) module 223, a planner module 225, a natural language generator (NLG) module 227, and/or a text to speech module (TTS) module 229.

According to an embodiment, the ASR module 221 may convert the voice input received from the user terminal 100 into text data. According to an embodiment, the NLU module 223 may grasp the intent of the user, using the text data of the voice input. For example, the NLU module 223 may grasp the intent of the user by performing syntactic analysis or semantic analysis. According to an embodiment, the NLU module 223 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 225 may generate the plan by using the intent and a parameter, which are determined by the NLU module 223. According to an embodiment, the planner module 225 may determine a plurality of domains necessary to perform a task, based on the determined intent. The planner module 225 may determine a plurality of actions included in each of the plurality of domains determined based on the intent. According to an embodiment, the planner module 225 may determine the parameter necessary to perform the determined plurality of actions or a result value output by the execution of the plurality of actions. The parameter and the result value may be defined as a concept of a specified form (or class). As such, the plan may include the plurality of actions and a plurality of concepts, which are determined by the intent of the user. The planner module 225 may determine the relationship between the plurality of actions and the plurality of concepts stepwise (or hierarchically). For example, the planner module 225 may determine the execution sequence of the plurality of actions, which are determined based on the user's intent, based on the plurality of concepts. In other words, the planner module 225 may determine an execution sequence of the plurality of actions, based on the parameters necessary to perform the plurality of actions and the result output by the execution of the plurality of actions. Accordingly, the planner module 225 may generate a plan including information (e.g., ontology) about the relationship between the plurality of actions and the plurality of concepts. The planner module 225 may generate the plan, using information stored in the capsule DB 230 storing a set of relationships between concepts and actions.

According to an embodiment, the NLG module 227 may change specified information into information in a text form. The information changed to the text form may be in the form of a natural language speech. The TTS module 229 according to an embodiment may change information in the text form to information in a voice form.

The capsule DB 230 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 230 may store the plurality of capsules in a form of a concept action network (CAN). According to an embodiment, the plurality of capsules may be stored in the function registry included in the capsule DB 230.

The capsule DB 230 may include a strategy registry that stores strategy information necessary to determine a plan corresponding to a voice input. When there are a plurality of plans corresponding to the voice input, the strategy information may include reference information for determining one plan. According to an embodiment, the capsule DB 230 may include a follow-up registry that stores information of the follow-up action for suggesting a follow-up action to the user in a specified context. For example, the follow-up action may include a follow-up utterance. According to an embodiment, the capsule DB 230 may include a layout registry storing layout information of information output via the user terminal 100. According to an embodiment, the capsule DB 230 may include a vocabulary registry storing vocabulary information included in capsule information. According to an embodiment, the capsule DB 230 may include a dialog registry storing information about dialog (or interaction) with the user. The capsule DB 230 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 230 according to an embodiment may be also implemented in the user terminal 100.

According to an embodiment, the execution engine 240 may calculate a result by using the generated plan. The end user interface 250 may transmit the calculated result to the user terminal 100. Accordingly, the user terminal 100 may receive the result and may provide the user with the received result. According to an embodiment, the management platform 260 may manage information used by the intelligence server 200. According to an embodiment, the big data platform 270 may collect data of the user. According to an embodiment, the analytic platform 280 may manage quality of service (QoS) of the intelligence server 200. For example, the analytic platform 280 may manage the component and processing speed (or efficiency) of the intelligence server 200.

According to an embodiment, the service server 300 may provide the user terminal 100 with a specified service (e.g., ordering food or booking a hotel). According to an embodiment, the service server 300 may be a server operated by the third party. According to an embodiment, the service server 300 may provide the intelligence server 200 with information for generating a plan corresponding to the received voice input. The provided information may be stored in the capsule DB 230. Furthermore, the service server 300 may provide the intelligence server 200 with result information according to the plan.

In the above-described integrated intelligence system, the user terminal 100 may provide the user with various intelligent services in response to a user input. The user input may include, for example, an input through a physical button, a touch input, or a voice input.

According to an embodiment, the user terminal 100 may provide a speech recognition service via an intelligence app (or a speech recognition app) stored therein. In this case, for example, the user terminal 100 may recognize a user utterance or a voice input, which is received via the microphone, and may provide the user with a service corresponding to the recognized voice input.

According to an embodiment, the user terminal 100 may perform a specified action, based on the received voice input, independently, or together with the intelligence server and/or the service server. For example, the user terminal 100 may launch an app corresponding to the received voice input and may perform the specified action via the executed app.

According to an embodiment, when providing a service together with the intelligence server 200 and/or the service server, the user terminal 100 may detect a user utterance by using the microphone 120 and may generate a signal (or voice data) corresponding to the detected user utterance. The user terminal may transmit the voice data to the intelligence server 200, using the communication interface 110.

According to an embodiment, the intelligence server 200 may generate a plan for performing a task corresponding to the voice input or the result of performing an action depending on the plan, as a response to the voice input received from the user terminal 100. For example, the plan may include a plurality of actions for performing a task corresponding to the voice input of the user and a plurality of concepts associated with the plurality of actions. The concept may define a parameter to be input upon executing the plurality of actions or a result value output by the execution of the plurality of actions. The plan may include relationship information between the plurality of actions and the plurality of concepts.

According to an embodiment, the user terminal 100 may receive the response, using the communication interface 110. The user terminal 100 may output the voice signal generated in the user terminal 100 to the outside by using the speaker 130 or may output an image generated in the user terminal 100 to the outside by using the display 140.

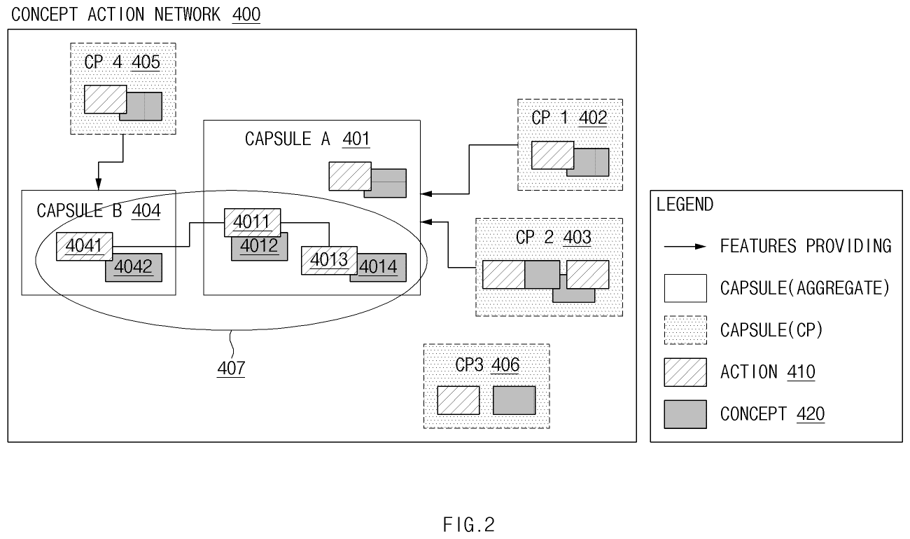

FIG. 2 is a diagram illustrating a form in which relationship information between a concept and an action is stored in a database, according to various embodiments.

A capsule database (e.g., the capsule DB 230) of the intelligence server 200 may store a capsule in the form of a concept action network (CAN). The capsule DB may store an action for processing a task corresponding to a user's voice input and a parameter necessary for the action, in the CAN form.

The capsule DB may store a plurality capsules a capsule A 401 and a capsule B 404 respectively corresponding to a plurality of domains (e.g., applications). According to an embodiment, a single capsule (e.g., the capsule A 401) may correspond to a single domain (e.g., a location (geo) or an application). Furthermore, at least one service provider (e.g., CP 1 402 or CP 2 403) for performing a function for a domain associated with the capsule may correspond to one capsule. According to an embodiment, the single capsule may include at least one or more actions 410 and at least one or more concepts 420 for performing a specified function.

The natural language platform 220 may generate a plan for performing a task corresponding to the received voice input, using the capsule stored in a capsule database. For example, the planner module 225 of the natural language platform may generate the plan by using the capsule stored in the capsule database. For example, a plan 407 may be generated by using actions 4011 and 4013 and concepts 4012 and 4014 of the capsule A 410 and an action 4041 and a concept 4042 of the capsule B 404.

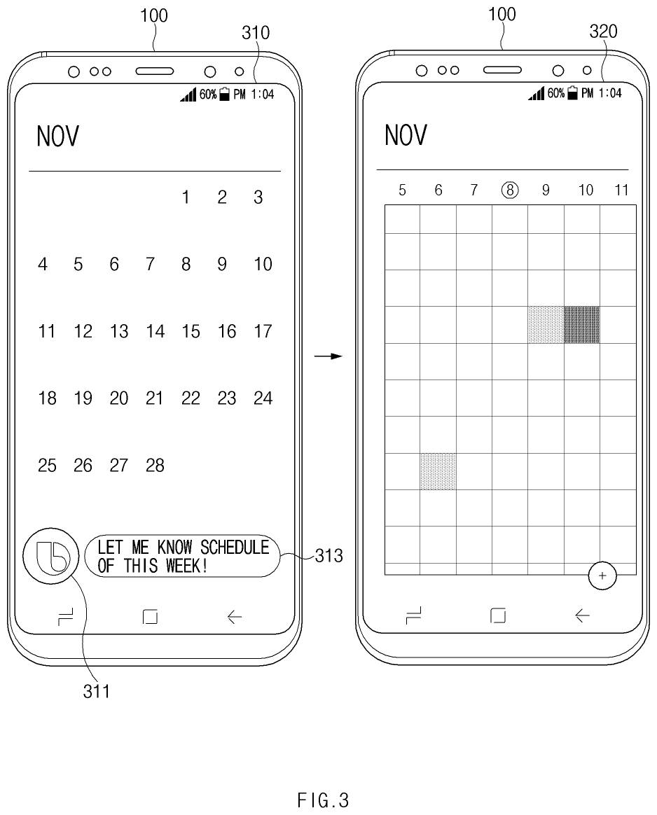

FIG. 3 is a view illustrating a screen in which a user terminal processes a voice input received through an intelligence app, according to various embodiments.

The user terminal 100 may execute an intelligence app to process a user input through the intelligence server 200.

According to an embodiment, on screen 310, when recognizing a specified voice input (e.g., wake up!) or receiving an input via a hardware key (e.g., a dedicated hardware key), the user terminal 100 may launch an intelligence app for processing a voice input. For example, the user terminal 100 may launch the intelligence app in a state where a schedule app is executed. According to an embodiment, the user terminal 100 may display an object (e.g., an icon) 311 corresponding to the intelligence app, on the display 140. According to an embodiment, the user terminal 100 may receive a voice input by a user utterance. For example, the user terminal 100 may receive a voice input saying that “let me know the schedule of this week!”. According to an embodiment, the user terminal 100 may display a user interface (UI) 313 (e.g., an input window) of the intelligence app, in which text data of the received voice input is displayed, on a display.

According to an embodiment, on screen 320, the user terminal 100 may display a result corresponding to the received voice input, on the display. For example, the user terminal 100 may receive the plan corresponding to the received user input and may display ‘the schedule of this week’ on the display depending on the plan.

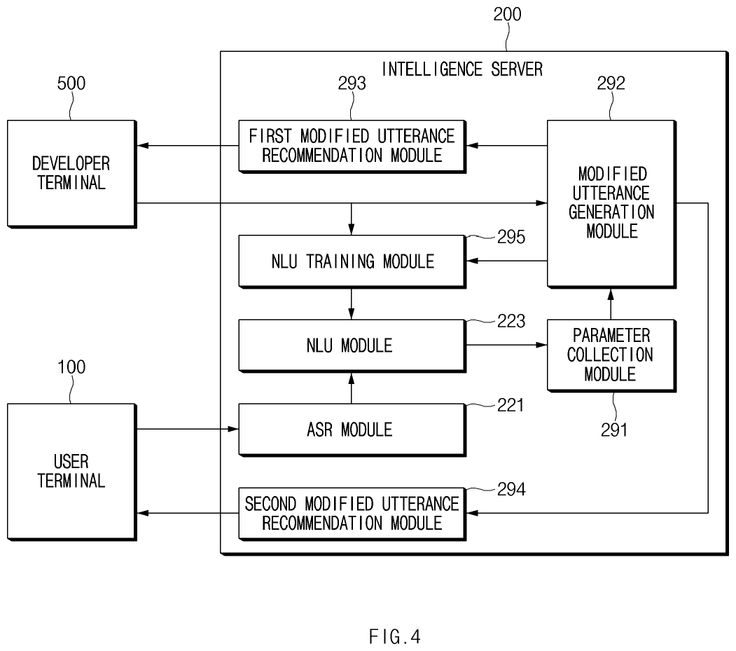

FIG. 4 is a block diagram illustrating an intelligence server generating a modified utterance text set according to an embodiment. In FIG. 4, descriptions of components that are identical to components given in the above-described drawings will be omitted.

Referring to FIG. 4, the intelligence server 200 may include at least part (e.g., the ASR module 221 and the NLU module 223) of configurations described with reference to FIG. 1, a parameter collection module 291, a modified utterance generation module 292, first and second modified utterance recommendation modules 293 and 294, and an NLU training module 295.

According to an embodiment, the intelligence server 200 may include at least one communication circuit, a memory, and a processor. The communication circuit may establish a communication channel with at least one of at least one external electronic device (e.g., a developer terminal 500 or the user terminal 100) and may transmit or receive data with the external electronic device through the communication channel The memory may store various data, commands, algorithms, engines, and the like associated with the operation of the intelligence server 200. The processor may operate the parameter collection module 291, the modified utterance generation module 292, the first and second modified utterance recommendation modules 293 and 294, and the NLU training module 295 by executing commands stored in the memory. The intelligence server 200 may transmit or receive data (or information) with an external electronic device (e.g., the user terminal 100 or the developer terminal 500) through the communication circuit.

According to an embodiment, the user terminal 100 may receive a user's utterance as a user input and may transmit the user input (e.g., voice data) to the ASR module 221. The ASR module 221 may convert the user input received from the user terminal 100 into a user utterance text. The user utterance text may be delivered to the modified utterance generation module 292 through the NLU module 223 and the parameter collection module 291. The modified utterance generation module 292 may generate a modified utterance text set corresponding to the user utterance text. The modified utterance text set may include a plurality of modified utterance texts. The user terminal 100 may be configured to be identical or similar to the user terminal 100 of FIG. 1.

According to an embodiment, the developer terminal 500 may transmit the training utterance text set for training the NLU module 223 to the modified utterance generation module 292 and the NLU training module 295. For example, the training utterance text set may be written by a developer. The developer terminal 500 may include an utterance input device. The developer may enter a representative utterance text (e.g., an utterance predicted as being frequently used by users in each service) by using the utterance input device, and may enter an application utterance text corresponding to the representative utterance text into the developer terminal 500 depending on a domain, intent, and a parameter. The developer terminal 500 may store a training utterance text set including the representative utterance text and an application utterance text. For example, the training utterance text set may be entered manually by the developer. The training utterance text set may include a plurality of training utterance texts written by the developer. The modified utterance generation module 292 may generate the modified utterance text set corresponding to the training utterance text set received from the developer terminal 500. The developer terminal 500 may be configured to be identical or similar to the user terminal 100 of FIG. 1.

According to an embodiment, the developer may enter training utterance information (e.g., domain information, category information, user utterance example information, and intent information) for generating a training utterance text set through an utterance input device. The developer terminal 500 may transmit the training utterance information to the modified utterance generation module 292. The modified utterance generation module 292 may generate a modified utterance text set based on the training utterance information received from the developer terminal 500.

According to an embodiment, the intelligence server 200 may operate in an NLU training mode (or a function) for training the NLU module 223 by receiving the training utterance text set. For example, in the NLU training mode, the NLU training module 295 may train the NLU module 223 based on the training utterance text set. However, because the training utterance text set is manually generated by the developer, the performance of the training method based on the training utterance text set may depend on the developer's ability. The intelligence server 200 according to an embodiment of the disclosure may train the NLU module 223 by generating an additional utterance text to improve training performance.

According to an embodiment, the modified utterance generation module 292 may generate an additional modified utterance text set by receiving the training utterance text set (or training utterance information). The NLU training module 295 may additionally train the NLU module 223 based on the modified utterance text set. The NLU module 223 may be trained by using the training utterance text set and the modified utterance text set. The training effect of the NLU module 223 may be improved as compared to a situation where training is performed by using only the training utterance text set.

According to an embodiment, the intelligence server 200 may operate in an utterance recommendation mode (or a function) that provides a developer or an inventor with a modified utterance text set based on a training utterance text set or a user utterance text.

According to an embodiment, when receiving the training utterance text set (or training utterance information), the modified utterance generation module 292 may generate a modified utterance text set corresponding to the training utterance text set (or the training utterance information). The generated modified utterance text set may be transmitted to the first modified utterance recommendation module 293. The first modified utterance recommendation module 293 may transmit the generated modified utterance text set to the developer terminal 500. The developer may generate a new training utterance text set by utilizing the modified utterance text set. For example, a developer may enter training utterance information (e.g., domain information, category information, user utterance example information, and intent information) through the utterance input device running in the developer terminal 500. The utterance input device may generate a training utterance text set based on the input training utterance information. The utterance input device may provide the developer with a modified utterance text set in a process of receiving the training utterance information. The developer may enter more various user utterance examples with reference to the provided modified utterance text set. The utterance input device may generate a new training utterance text set by adding newly entered user utterance examples to the pre-stored training utterance text. The developer terminal 500 may transmit a new training utterance text set to the intelligence server 200, and the NLU training module 295 may utilize the new training utterance text set. Accordingly, the training performance of the NLU module 223 may be improved.

According to an embodiment, when a user utterance is input to the user terminal 100, a user utterance may be converted to a user utterance text through the ASR module 221 and the NLU module 223. When receiving the user utterance text, the modified utterance generation module 292 may generate a modified utterance text set corresponding to the user utterance text. The generated modified utterance text set may be transmitted to the second modified utterance recommendation module 294. The second modified utterance recommendation module 294 may transmit the generated modified utterance text set to the user terminal 100. The user terminal 100 may provide a modified utterance text set when a user utterance is entered. For example, when the user utterance text initially recognized by the user terminal 100 is not matched with a user's intent, the user may receive a recommendation for an utterance text (e.g., a modified utterance text set) similar to (or familiar with the user) a user utterance pattern. The user terminal 100 may recommend an utterance text (e.g., “turn off the phone”) similar to a user utterance pattern (familiar with the user) for a user utterance (e.g., “hang up the phone”), not a representative utterance (e.g., “end the phone”). Because the user's utterance pattern is diverse and an utterance model used in the NLU module 223 is also diverse, the utterance pattern frequently employed by the user may be different from the utterance pattern processed well by the NLU module 223. Accordingly, the user utterance that the NLU module 223 is incapable of processing may occur. The modified utterance text set generated by the modified utterance generation module 292 may make up for a portion that the NLU module 223 is incapable of processing.

According to an embodiment, in an NLU training mode or an utterance recommendation mode, the modified utterance generation module 292 may generate a modified utterance text set based on a variety of criteria. The modified utterance generation module 292 may generate a modified utterance text set based on a user utterance.

According to an embodiment, a user utterance data obtained by converting the user input entered in the past into a text may be stored in a natural language recognition database through the NLU module 223. The parameter collection module 291 may generate user utterance classification information by receiving user utterance data from a natural language recognition database. The user utterance classification information may include domain information about user utterance data, intent information about user utterance data, parameter information about user utterance data, and the like. The modified utterance generation module 292 may receive user utterance classification information from the parameter collection module 291, and may generate a modified utterance text set for each domain or for each intent based on the user utterance classification information.

According to an embodiment, when the number of training utterance texts included in the received training utterance text set in an NLU training mode is less than a reference utterance count, the modified utterance generation module 292 may generate the modified utterance text set. When the number of training utterance texts included in the training utterance text set is less than the reference utterance count, the training effect of the NLU module 223 may be reduced, and thus an additional modified utterance text set may be required.

According to an embodiment, the modified utterance generation module 292 may generate the modified utterance text set based on a generation model or a transfer learning model. For example, the generation model may include generative adversarial networks (GAN), variational autoencoder (VAE), deep neural network (DNN), or the like. The transfer learning model may include style-transfer or the like.

According to an embodiment, the modified utterance generation module 292 may include a generation module and an inspection module. For example, the generation module and the inspection module may implement the generation model. The generation module may generate a candidate utterance text by using user utterance data. The inspection module may determine whether the candidate utterance text is similar to a reference utterance text (e.g., a training utterance text set or a user utterance text). When the candidate utterance text is similar to the reference utterance text (e.g., when the degree of similarity is not less than a specified ratio), the inspection module may select a candidate utterance text similar to the reference utterance text as a modified utterance text set. The generation module and the inspection module may generate various modified utterance text sets similar to the reference utterance text by repeating the generation and inspection while differently setting at least one of a domain, intent, and a parameter.

According to an embodiment, the modified utterance generation module 292 may determine a domain (e.g., a first domain) of the reference utterance text. The modified utterance generation module 292 may determine a second domain similar to the first domain. The modified utterance generation module 292 may generate a modified utterance text set for the training of the NLU module 223 with respect to the first domain, in the second domain.

According to an embodiment, the second domain similar to the first domain may be determined based on a category. For example, when the category of the first domain (e.g., Pizza Hut app) is “pizza delivery”, the second domain (e.g., Domino's Pizza app) may be selected from domains (e.g., Domino's Pizza app and Mr. Pizza app) within the category of “pizza delivery”.

According to an embodiment, the second domain similar to the first domain may be determined based on intent. For example, when the intent of the first domain (e.g., a message app) is “sending a message”, the second domain (e.g., KakaoTalk app) may be selected from domains (e.g., KakaoTalk app and Line app) with an intent of “sending a message”.

According to an embodiment, the modified utterance generation module 292 may generate a modified utterance text set through transfer learning. For example, the modified utterance generation module 292 may generate a modified utterance text set for the first domain by using the utterance pattern used in the second domain, not the first domain. The modified utterance generation module 292 may generate a modified utterance text set for the first domain by transferring the intent used in the second domain to the first domain.

According to an embodiment, the modified utterance generation module 292 may generate a modified utterance text set based on a user feature.

According to an embodiment, the parameter collection module 291 may receive the user utterance data from the NLU module 223. The parameter collection module 291 may preprocess the user utterance data (processing at least one of noise cancellation, sample utterance extraction, or related utterance selection) and may change the preprocessed user utterance data to data in a format used by the modified utterance generation module 292. The parameter collection module 291 may generate information (hereinafter referred to as “user feature information”) about user features (e.g., ages, regions, or genders) by analyzing the preprocessed user utterance data. For example, the user feature information may include information about terms frequently used depending on to ages, regions, or genders. The user may utilize terms (e.g., “please”, “please help me”, “please do this”) having different forms for the same meaning depending on the user features.

According to an embodiment, the parameter collection module 291 may extract frequently used utterance patterns depending on ages, regions, and genders based on the user feature information. For example, the user utterance pattern based on the user features may include utterance patterns frequently used by 20s, utterance patterns frequently used by 40s, utterance patterns frequently used in Busan, utterance patterns frequently used in Jeju Island, utterance patterns frequently used by men, utterance patterns frequently used by women, and the like.

According to an embodiment, when the number of extracted user utterance patterns is greater than the reference pattern count, the modified utterance generation module 292 may generate a modified utterance text set based on a user utterance pattern. For example, the modified utterance generation module 292 may compare the number of user utterance patterns and the reference pattern count. When the number of specific user utterance patterns is greater than the reference pattern count, it means that the specific user utterance pattern is often used by users. Accordingly, the modified utterance generation module 292 may use a specific user utterance pattern to generate an additional modified utterance text set. The reference pattern count may be determined based on an utterance quantity. The reference pattern count may be determined depending on utterance complexity. For example, utterance complexity may be proportional to the number of parameters (or slots) included in a user utterance. In the case of a user utterance (e.g., a user utterance having a lot of many parameters (or slots) included in the user utterance), the reference pattern count may be set to be low.

According to an embodiment, the modified utterance generation module 292 may generate a modified utterance text set through transfer learning based on user feature information. For example, the modified utterance generation module 292 may generate a modified utterance text set for the first domain, which is frequently used by 30s, using utterance patterns used in the second domain that is often used by 10's.

As described above, according to various embodiments, the intelligence server 200 may generate various modified utterance text sets in response to a training utterance text set received from the developer terminal 500 or a user input received from the user terminal 100. The intelligence server 200 may train the NLU module 223 by using the generated modified utterance text set. The intelligence server 200 may transmit the modified utterance text set, which is generated to be used for the developer to write the training utterance text set, to a developer terminal. The intelligence server 200 may transmit the generated modified utterance text set to a user terminal such that the user is capable of easily selecting an operation corresponding to a user utterance.

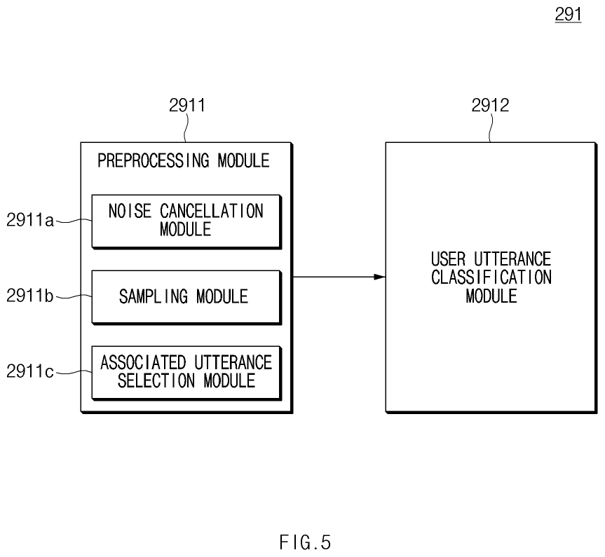

FIG. 5 is a block diagram illustrating an example of the parameter collection module of FIG. 4.

Referring to FIG. 5, the parameter collection module 291 may include a preprocessing module 2911 and a user utterance classification module 2912. The preprocessing module 2911 may include a noise cancellation module 2911a, a sampling module 2911b, and an associated utterance selection module 2911c.

According to an embodiment, user utterance data received from the NLU module 223 may have a feature including a lot of noise (e.g., ambient noise included between the start and end of user utterance), a lot of user utterances (e.g., the number of user utterances that are collected and accumulated or are stored in the NLU module 223), unbalance (e.g., not being classified for each category or domain), and uncertainty (e.g., an utterance of which the result is ambiguous by the NLU module 223, an utterance of an unknown domain, or an utterance that is incapable of being understood by the NLU module 223 (e.g., “there was a light black color yesterday”)). The preprocessing module 2911 may preprocess the user utterance data having the feature and may change the preprocessed user utterance data to a format to be used by the modified utterance generation module 292. The noise cancellation module 2911a may remove noise by using a filtering scheme or an ensemble scheme. The sampling module 2911b may extract a patterned sample utterance from the user utterance data. The sampling module 2911b may reduce the amount of user utterance data by extracting a repeated sample utterance. The associated utterance selection module 2911c may remove a user utterance, which is semantically less associated with a reference utterance text (e.g., a training utterance text set or a user utterance text) from the user utterance data. That is, the associated utterance selection module 2911c may select a user utterance that is highly associated with the reference utterance text.

According to an embodiment, the user utterance classification module 2912 may receive the preprocessed user utterance data from the preprocessing module 2911. The user utterance classification module 2912 may generate user utterance classification information based on the preprocessed user utterance data, and may transmit the preprocessed user utterance data and the user utterance classification information to the modified utterance generation module 292. In the meantime, the user utterance classification module 2912 may receive a current user utterance text from the NLU module 223. The user utterance classification module 2912 may transmit the current user utterance text to the modified utterance generation module 292.

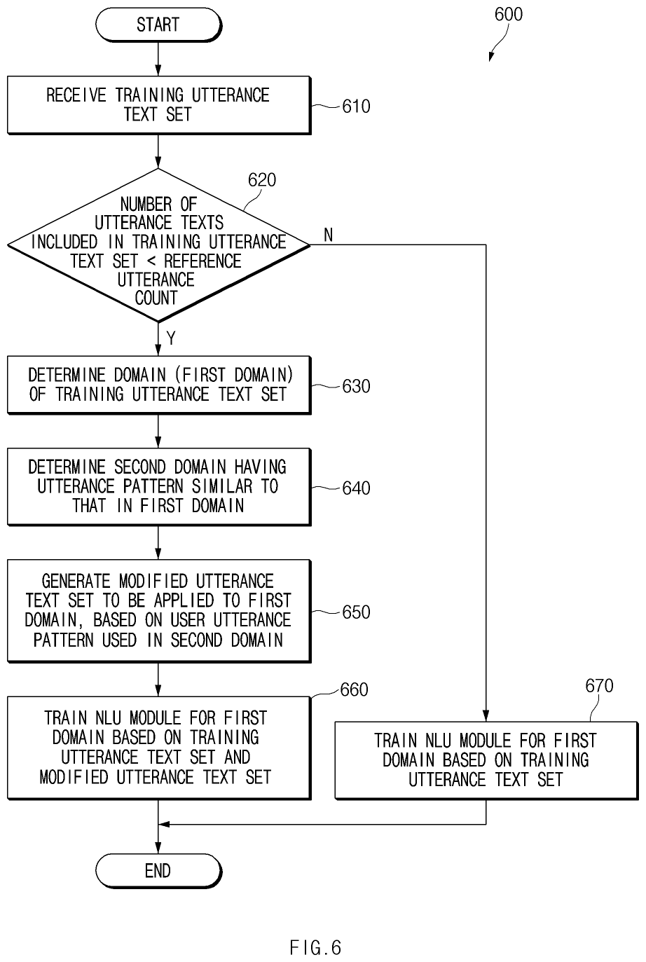

FIG. 6 is a flowchart illustrating a method 600 of operating an intelligence server in an NLU training mode according to an embodiment. The operation method 600 of the intelligence server may be performed differently depending on the number of training utterance text sets included in a training utterance text set in the NLU training mode.

Referring to FIG. 6, in operation 610, the intelligence server 200 may receive a training utterance text set. For example, the modified utterance generation module 292 may receive the training utterance text set from the developer terminal 500. The training utterance text set may include a plurality of training utterance text sets written by a developer.

According to an embodiment, in operation 620, the intelligence server 200 may compare the number of training utterance text sets included in the training utterance text set with the reference utterance count. For example, when the number of training utterance text sets included in the training utterance text set is less than the reference utterance count, the modified utterance generation module 292 may perform operations (operation 630 to operation 660) of generating the modified utterance text set. When the number of training utterance text sets included in the training utterance text set is not less than the reference utterance count, operation 670 may be performed.

According to an embodiment, when the number of training utterance text sets included in the training utterance text set is less than the reference utterance count, in operation 630, the intelligence server 200 may determine a domain (e.g., a first domain) of the training utterance text set. For example, the modified utterance generation module 292 may determine the domain of the training utterance text set by using the NLU module 223.

According to an embodiment, in operation 640, the intelligence server 200 may determine a second domain having an utterance pattern similar to that in the first domain. For example, the modified utterance generation module 292 may determine a second domain similar to the first domain based on a category. For example, when the category of the first domain (e.g., Pizza Hut app) is “pizza delivery business”, the second domain (e.g., Domino's Pizza app) may be selected from domains (e.g., Domino's Pizza app or Mr. Pizza app) within the category of “pizza delivery”. According to various embodiments, the modified utterance generation module 292 may determine the second domain similar to the first domain based on intent. For example, when the intent of the first domain (e.g., a message app) is “sending a message”, the second domain (e.g., KakaoTalk app) may be selected from domains (e.g., KakaoTalk app and Line app) with an intent of “sending a message”.

According to an embodiment, in operation 650, the intelligence server 200 may generate a modified utterance text set to be applied to the first domain, based on the user utterance pattern used in the second domain. For example, the parameter collection module 291 may receive user utterance data from the NLU module 223. The parameter collection module 291 may preprocess the user utterance data (processing noise cancellation, sample utterance extraction, or related utterance selection) and may change the preprocessed user utterance data to data in a format used in the modified utterance generation module 292. The parameter collection module 291 may generate user utterance classification information based on the preprocessed user utterance data, and may transmit the preprocessed user utterance data and the user utterance classification information to the modified utterance generation module 292. The modified utterance generation module 292 may extract a user utterance pattern used in the second domain, based on user utterance classification information. The modified utterance generation module 292 may generate a modified utterance text set to be applied to the first domain, using the extracted user utterance pattern. The modified utterance text set may include a plurality of modified utterance text sets.

According to an embodiment, in operation 660, the intelligence server 200 may train the NLU module 223 for the first domain based on the received training utterance text set and the generated modified utterance text set. For example, the NLU training module 295 may receive a training utterance text set from the developer terminal 500. The NLU training module 295 may train the NLU module 223 based on the training utterance text set. In addition, the NLU training module 295 may receive a modified utterance text set from the modified utterance generation module 292. The NLU training module 295 may additionally train the NLU module 223 based on the modified utterance text set. Accordingly, the performance of the NLU module 223 may be improved as compared to a case that the NLU module 223 has been trained by using only the training utterance text set.

According to an embodiment, when the number of training utterance text sets included in the training utterance text set is not less than the reference utterance count, in operation 670, the intelligence server 200 may train the NLU module 223 for the first domain based on the training utterance text set. For example, when the number of training utterance text sets included in the training utterance text set is not less than the reference utterance count, a training utterance text set that is already enough for the first domain may be present. In this case, the modified utterance generation module 292 may not be operated. Accordingly, the NLU training module 295 may train the NLU module 223 by receiving the training utterance text set from the developer terminal 500.

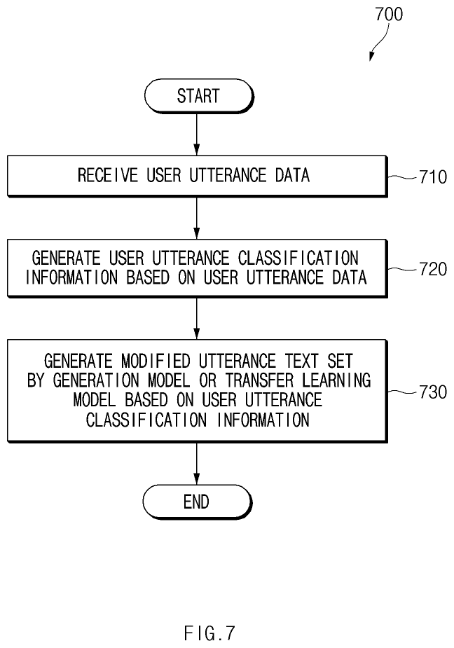

FIG. 7 is a flowchart illustrating an example of a method of generating a modified utterance text set in operation 650 of FIG. 6. A method 700 of generating the modified utterance text set of FIG. 7 may be performed by a generation model or a transfer learning model depending on user utterance classification information generated based on user utterance data.

Referring to FIG. 7, in operation 710, the parameter collection module 291 may receive user utterance data. For example, the parameter collection module 291 may receive user utterance data from the NLU module 223. The parameter collection module 291 may preprocess the user utterance data (processing noise cancellation, sample utterance extraction, or related utterance selection) and may change the preprocessed user utterance data to data in a format used in the modified utterance generation module 292.

According to an embodiment, in operation 720, the parameter collection module 291 may generate user utterance classification information based on user utterance data. For example, the parameter collection module 291 may generate user utterance classification information based on the preprocessed user utterance data, and may transmit the preprocessed user utterance data and the user utterance classification information to the modified utterance generation module 292.

According to an embodiment, in operation 730, the modified utterance generation module 292 may generate a modified utterance text set by a generation model or a transfer learning model based on user utterance classification information. For example, the modified utterance generation module 292 may extract a user utterance pattern used in the second domain, based on user utterance classification information. The modified utterance generation module 292 may generate a modified utterance text set to be applied to the first domain, using the extracted user utterance pattern. The modified utterance text set may include a plurality of modified utterance text sets. A plurality of modified utterance text sets may be generated by the generation model or the transfer learning model based on the intent and parameter used in the second domain.

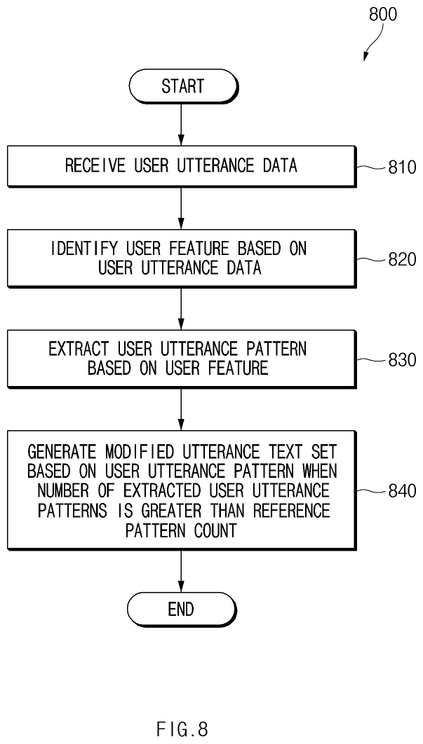

FIG. 8 is a flowchart illustrating another example of a method of generating a modified utterance text set in operation 650 of FIG. 6. A method 800 of generating the modified utterance text set of FIG. 8 may be performed depending on a user feature identified based on user utterance data.

Referring to FIG. 8, in operation 810, the parameter collection module 291 may receive user utterance data. For example, the parameter collection module 291 may receive user utterance data from the NLU module 223. The parameter collection module 291 may preprocess the user utterance data (processing noise cancellation, sample utterance extraction, or related utterance selection) and may change the preprocessed user utterance data to data in a format used in the modified utterance generation module 292.

According to an embodiment, in operation 820, the parameter collection module 291 may identify user features based on user utterance data. For example, the parameter collection module 291 may generate information (hereinafter referred to as “user feature information”) about the user features (e.g., ages, regions, or genders) by analyzing the preprocessed user utterance data. The user feature information may include information about terms frequently used depending on to ages, regions, or genders. The user may utilize terms (e.g., “please”, “please help me”, “please do this”) having different forms for the same meaning depending on the user features.

According to an embodiment, in operation 830, the parameter collection module 291 may extract a user utterance pattern based on the user feature. For example, the parameter collection module 291 may extract frequently used utterance patterns depending on ages, regions, and genders based on the user feature information. For example, the user utterance pattern based on the user features may include utterance patterns frequently used by 20s, utterance patterns frequently used by 40s, utterance patterns frequently used in Busan, utterance patterns frequently used in Jeju Island, utterance patterns frequently used by men, utterance patterns frequently used by women, and the like.

According to an embodiment, when the number of extracted user utterance patterns is greater than the reference pattern count, in operation 840, the modified utterance generation module 292 may generate a modified utterance text set based on a user utterance pattern. For example, the modified utterance generation module 292 may compare the number of user utterance patterns and the reference pattern count. When the number of specific user utterance patterns is greater than the reference pattern count, it means that the specific user utterance pattern is often used by users. Accordingly, the modified utterance generation module 292 may use a specific user utterance pattern to generate an additional modified utterance text set. The reference pattern count may be determined based on an utterance quantity. The reference pattern count may be determined depending on utterance complexity. For example, in a case of a complex user utterance, the reference pattern count may be set to be low.

According to various embodiments, the modified utterance generation module 292 may generate a modified utterance text set through transfer learning based on user feature information. For example, the modified utterance generation module 292 may generate a modified utterance text set for the first domain, which is frequently used by 30s, using utterance patterns used in the second domain that is often used by 10's.

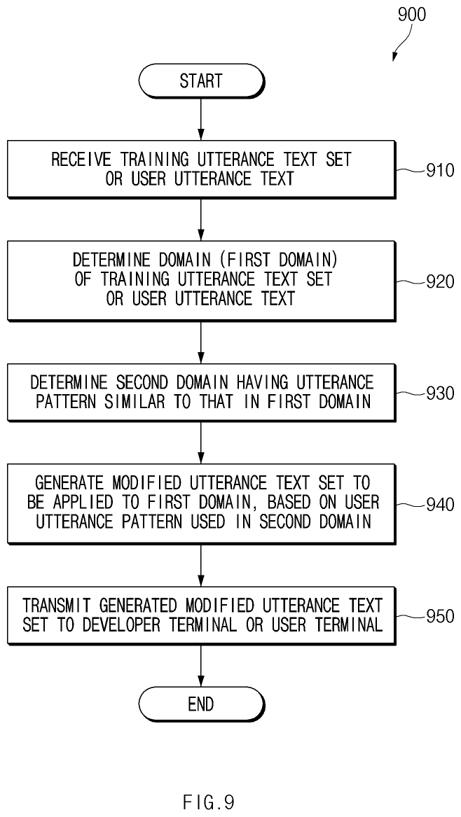

FIG. 9 is a flowchart illustrating an operation method 900 of an intelligence server in an utterance recommendation mode according to an embodiment. The operation method 900 of the intelligence server may be performed in response to a training utterance text set or a user utterance text received in the utterance recommendation mode.

Referring to FIG. 9, in operation 910, the modified utterance generation module 292 may receive a training utterance text set or a user utterance text. For example, the modified utterance generation module 292 may receive the training utterance text set from the developer terminal 500. The training utterance text set may include a plurality of training utterance text sets written by a developer. Besides, the modified utterance generation module 292 may receive the user utterance text from the NLU module 223 through the parameter collection module 291. The ASR module 221 may convert the user input (e.g., a user utterance) received from the user terminal 100 into a user utterance text.

According to an embodiment, in operation 920, the modified utterance generation module 292 may determine a domain (a first domain) of the training utterance text set or the user utterance text. For example, the modified utterance generation module 292 may determine the domain of the training utterance text set or the user utterance text, using the NLU module 223.

According to an embodiment, in operation 930, the modified utterance generation module 292 may determine a second domain having an utterance pattern similar to that in the first domain. For example, the modified utterance generation module 292 may determine a second domain similar to the first domain based on a category. For example, when the category of the first domain (e.g., Pizza Hut app) is “pizza delivery business”, the second domain (e.g., Domino's Pizza app) may be selected from domains (e.g., Domino's Pizza app or Mr. Pizza app) within the category of “pizza delivery”. According to various embodiments, the modified utterance generation module 292 may determine the second domain similar to the first domain based on intent. For example, when the intent of the first domain (e.g., a message app) is “sending a message”, the second domain (e.g., KakaoTalk app) may be selected from domains (e.g., KakaoTalk app and Line app) with an intent of “sending a message”.

According to an embodiment, in operation 940, the modified utterance generation module 292 may generate a modified utterance text set to be applied to the first domain, based on the user utterance pattern used in the second domain. For example, the parameter collection module 291 may receive user utterance data from the NLU module 223. The parameter collection module 291 may preprocess the user utterance data (e.g., processing at least one of noise cancellation, sample utterance extraction, or related utterance selection) and may change the preprocessed user utterance data to data in a format used by the modified utterance generation module 292. The parameter collection module 291 may generate user utterance classification information based on the preprocessed user utterance data, and may transmit the preprocessed user utterance data and the user utterance classification information to the modified utterance generation module 292. The modified utterance generation module 292 may extract a user utterance pattern used in the second domain, based on user utterance classification information. The modified utterance generation module 292 may generate a modified utterance text set to be applied to the first domain, using the extracted user utterance pattern. The modified utterance text set may include a plurality of modified utterance text sets. For example, in operation 940, the modified utterance generation module 292 may generate the modified utterance text set through the modified utterance text set generation method of FIG. 7 or the modified utterance text set generation method of FIG. 8.

According to an embodiment, in operation 950, the intelligence server 200 may transmit the generated modified utterance text set to a developer terminal or a user terminal. For example, the modified utterance generation module 292 may transmit the modified utterance text set to the first modified utterance recommendation module 293 or the second modified utterance recommendation module 294. When receiving the training utterance text set from the developer terminal 500, the modified utterance generation module 292 may transmit the generated modified utterance text set to the first modified utterance recommendation module 293. The first modified utterance recommendation module 293 may transmit the modified utterance text set to the developer terminal 500. In the meantime, when receiving the user utterance text from the parameter collection module 291, the modified utterance generation module 292 may transmit the generated modified utterance text set to the second modified utterance recommendation module 294. The second modified utterance recommendation module 294 may transmit the modified utterance text set to the user terminal 100.

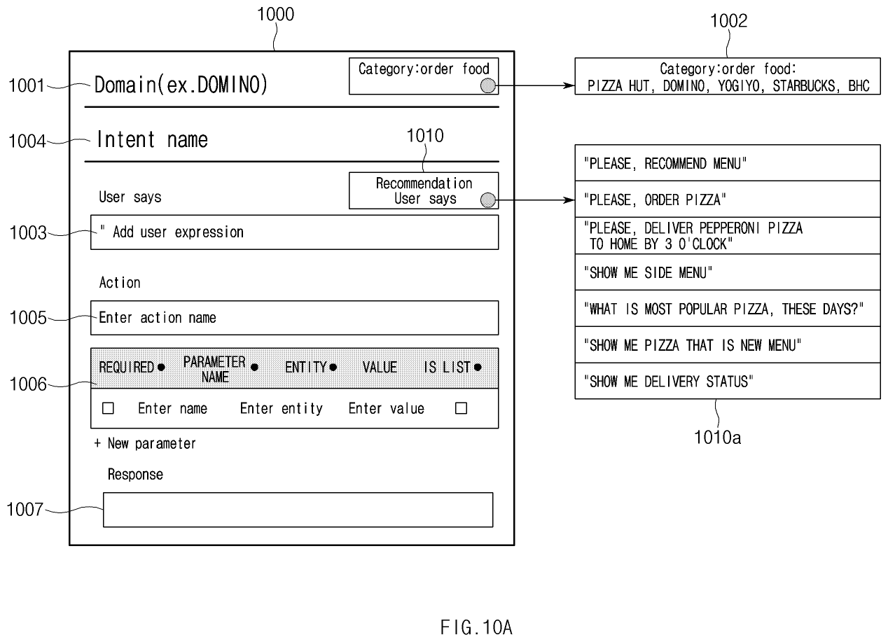

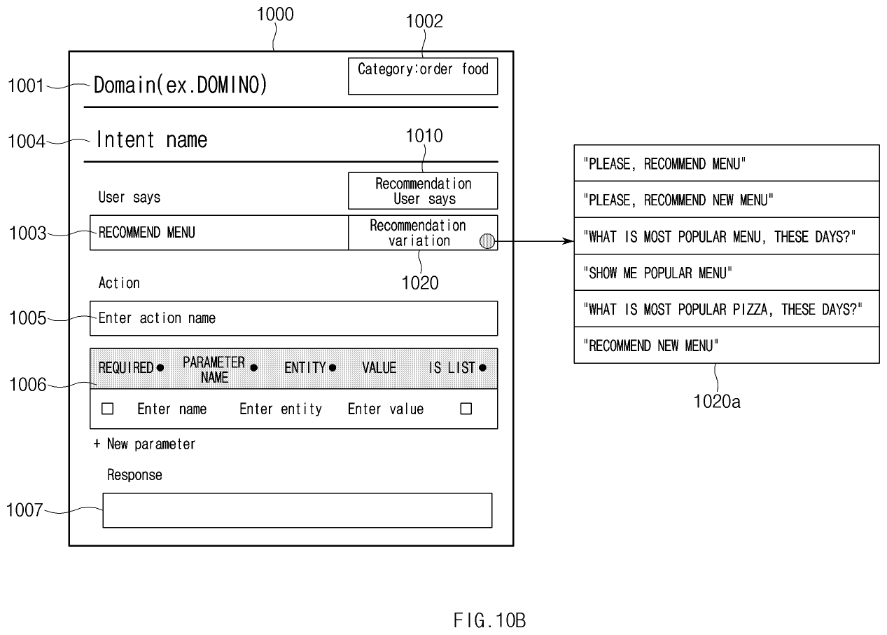

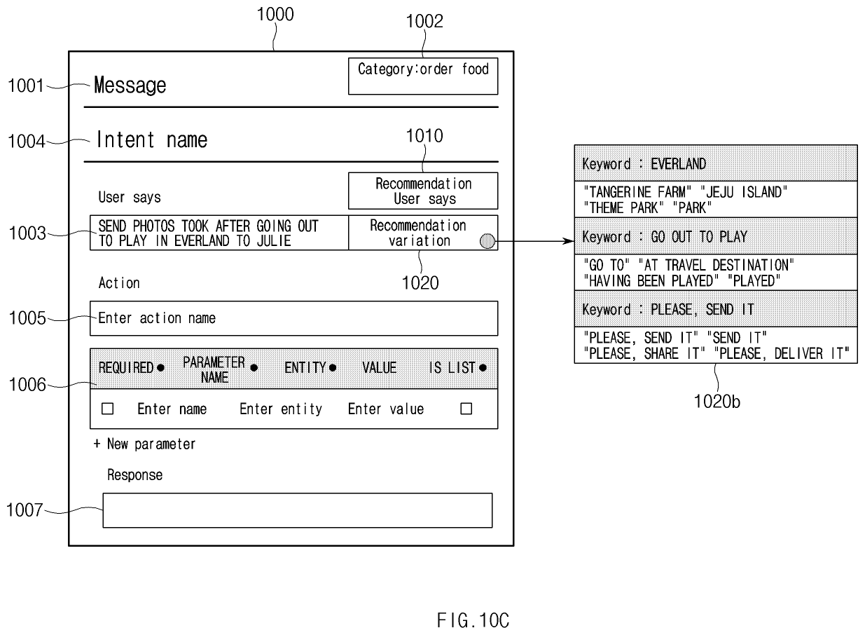

Hereinafter, an embodiment in which a modified utterance text set is recommended by a developer terminal will be described with reference to FIGS. 10A to 10C.

FIG. 10A is a diagram illustrating a method of recommending a modified utterance text depending on a category of a domain entered when a training utterance text is entered through an utterance input device, according to an embodiment.

FIG. 10B is a diagram illustrating a method of recommending a modified utterance text depending on intent of a user utterance example entered when a training utterance text is entered through an utterance input device, according to an embodiment.

FIG. 10C is a diagram illustrating a method of recommending modified utterance text depending on a keyword included in a user utterance example entered when a training utterance text is entered through an utterance input device, according to an embodiment.

Referring to FIGS. 10A to 10C, a developer terminal (e.g., the developer terminal 500 of FIG. 4) may display an utterance input device 1000 on a screen. The utterance input device 1000 may receive various items from a developer and may generate a training utterance text set for training an NLU module (e.g., the NLU module 223 in FIG. 4) of an intelligence server (e.g., the intelligence server 200 in FIG. 4). The intelligence server may train the NLU module by receiving the training utterance text set. In the meantime, the utterance input device 1000 may provide an additional user utterance (e.g., a modified utterance text) in a process of entering the various items.

According to an embodiment, a developer may enter a domain item 1001, a category item 1002, a user utterance example item 1003, an intent item 1004, an action item 1005, a parameter item 1006, and a response item 1007 through the utterance input device 1000. The utterance input device 1000 may generate a training utterance text based on entered domain information, entered category information, entered user utterance example information, entered intent information, entered action information, entered parameter information, and entered response information.

According to an embodiment, the developer terminal may transmit at least one of the entered domain information, the entered category information, the entered user utterance example information, the entered intent information, the entered action information, the entered parameter information, and the entered response information to the intelligence server. Besides, the developer terminal may transmit a training utterance text to the intelligence server. The intelligence server may generate a modified utterance text set based on at least one of the domain information, the category information, the user utterance example information, the intent information, the action information, the parameter information, and the response information. Moreover, the intelligence server may generate the modified utterance text set based on the training utterance text.

According to an embodiment, the intelligence server may transmit the modified utterance text set corresponding to at least one of the domain information, the category information, the user utterance example information, the intent information, the action information, the parameter information, and the response information to the developer terminal. Furthermore, the intelligence server may transmit the modified utterance text set corresponding to the training utterance text to the developer terminal. The modified utterance text set may be newly generated based on the modified utterance text set or at least one of the domain information, category information, user utterance example information, intent information, action information, parameter information, and response information, which have been generated in advance and stored or received. The modified utterance text set may be generated by the methods described in FIGS. 4 to 8.

According to an embodiment, the developer may enter a domain (e.g., Domino's Pizza, Pizza Hut, Alarm, and Calendar), in which a developer is in charge of development, into the domain item 1001. The developer may enter a category, to which the domain belongs, into the category item 1002. For example, when the domain is a service (e.g., Domino's Pizza, Pizza Hut, Yogiyo, Starbucks, or BHC) associated with ordering food, the developer may enter “order food” into the category item 1002. The category item 1002 may be directly entered by the developer or may be selected from candidates previously entered. The developer may enter a user utterance example (e.g., a representative utterance text or an application utterance text), which the user is expected to use, into the user utterance example item 1003. The developer may enter a plurality of user utterance examples (e.g., “menu recommendation”, “recommend a menu”, “please recommend a menu”, or “could you please recommend a menu”) having similar forms into the user utterance example item 1003. A plurality of user utterance examples entered into the user utterance example item 1003 may be recognized with the same intent (e.g., intent entered into the intent item 1004) by the intelligence server. The developer may enter intent (e.g., “recommending a menu” or “sending a message”) corresponding to a user utterance example into the intent item 1004. The developer may enter an action (e.g., “launching Domino's Pizza app”, “launching a message app”, or “turning on/off Wi-Fi”) corresponding to the intent into the action item 1005. The developer may enter pieces of content (e.g., place—Seoul, Gwangju, and Busan) of elements (e.g., place, time, and person) included in the user utterance example into the parameter item 1006. For example, the parameter item 1006 may be directly entered by a developer or may be entered based on data provided by a system (e.g., the developer terminal 500 or the intelligence server 200 in FIG. 4). The developer may enter a response (e.g., when intent is “sending a message”, a result notification for an action corresponding to the intent such as “the message has been sent”) corresponding to the intent in the response item 1007.

According to an embodiment, referring to FIG. 10A, when the domain item 1001 and the category item 1002 are entered, the utterance input device 1000 may display a recommendation user utterance 1010a. For example, when the domain item 1001 and the category item 1002 are entered through the utterance input device 1000, the developer terminal may transmit the entered domain information and the entered category information to the intelligence server, and may receive the modified utterance text set corresponding to the domain information and the category information from the intelligence server. The utterance input device 1000 may display the received modified utterance text set in the recommendation user utterance 1010a. Alternatively, the utterance input device 1000 may display the recommendation user utterance 1010a based on the received modified utterance text set. For example, the recommendation user utterance 1010a is generated (e.g., “recommend a menu”, “order a pizza”, “show me a delivery status”) based on user utterances used in another domain (e.g., Pizza Hut, Starbucks, or BHC) belonging to the same category as the entered domain (e.g., Domino's Pizza). The developer may additionally write the user utterance example item 1003 with reference to the recommendation user utterance 1010a.

According to an embodiment, referring to FIG. 10B, when the domain item 1001, the category item 1002, the user utterance example item 1003, and the intent item 1004 are entered, the utterance input device 1000 may display a recommendation modified utterance 1020a. For example, when the domain item 1001, the category item 1002, the user utterance example item 1003, and the intent item 1004 are entered through the utterance input device 1000, the developer terminal may transmit the entered domain information, the entered category information, the entered user utterance example information, and the entered intent information to the intelligence server, and may receive a modified utterance text set corresponding to the domain information, the category information, the user utterance example information, and the intent information from the intelligence server. The utterance input device 1000 may display the recommendation modified utterance 1020a based on the received modified utterance text set. For example, the recommendation modified utterance 1020a is generated (e.g., “please, recommend a new menu”, “show me a popular menu”, or “what is the most popular pizza, these days”) based on user utterances used in a similar domain (e.g., a domain determined as being similar to the entered domain by the intelligence server) having intent (e.g., intent determined as being similar to the entered intent by the intelligence server) similar to the entered intent (e.g., recommending a menu). The developer may additionally write the user utterance example item 1003 with reference to the recommendation modified utterance 1020a.

According to an embodiment, referring to FIG. 10C, the utterance input device 1000 may display a recommendation modified utterance 1020b based on the received modified utterance text set. For example, the recommendation modified utterance 1020b may be generated for each keyword (e.g., Everland, go out to play, or send it) included in a user utterance example (e.g., “send photos took after going out to play in Everland to Julie.”). The developer may additionally write the user utterance example item 1003 with reference to the recommendation modified utterance 1020b.

As described above, according to various embodiments, the developer terminal may provide a recommendation user utterance 1010 or a recommendation modified utterance 1020 through the utterance input device 1000. Accordingly, the developer may enter an additional user utterance example based on the recommendation user utterance 1010 or the recommendation modified utterance 1020. The utterance input device 1000 may generate various training utterance text sets.

According to various embodiments, the developer terminal 500 may transmit a domain and a category to the intelligence server 200, and may receive a modified utterance text (or a modified utterance text set) corresponding to the domains and the category from the intelligence server 200. The modified utterance text (or the modified utterance text set) may be generated through a generation model or a transfer learning model, based on user utterance data stored in advance in the intelligence server 200. The intelligence server 200 may convert voice data, which is transmitted to the intelligence server 200 by the user terminal receiving a user utterance, into a text and may store the text as the user utterance data. For example, the generation model may include generative adversarial networks (GAN), variational autoencoder (VAE), and a deep neural network (DNN). The transfer learning model may include style-transfer.

According to various embodiments, the developer terminal 500 may transmit the domain, the category, and the user utterance example (e.g., a training utterance text or a training utterance text set) to the intelligence server 200 and may receive a modified utterance text (or a modified utterance text set) corresponding to the domain, the category, and the user utterance example.

According to various embodiments, the developer terminal 500 may display a plurality of second parameters in response to one parameter (a first parameter) included in the training utterance text (or the training utterance text set) based on the received modified utterance text (or the modified utterance text set). When one of the plurality of second parameters is selected, the developer terminal 500 may display the modified utterance text (or the modified utterance text set) including the selected parameter.

According to various embodiments, the intelligence server 200 may set a domain received from the developer terminal 500 as a first domain, may determine a second domain having an utterance pattern similar to an utterance pattern in the first domain within a category received from the developer terminal 500, and may generate a modified utterance text based on the utterance pattern in the second domain. For example, the intelligence server 200 may determine a domain, in which intent similar to intent used in the first domain is used, as the second domain. Alternatively, the intelligence server 200 may determine the intent of the training utterance text (or the training utterance text included in the training utterance text set) and may determine a domain, in which intent similar to intent of the training utterance text is used, as the second domain. According to an embodiment, the intelligence server 200 may determine parameters included in the training utterance text (or the training utterance text set) and may generate a modified utterance text set by using parameters of the second domain similar to the parameters.

According to various embodiments, when the number of training utterance texts included in the training utterance text set is less than a reference utterance count, the intelligence server 200 may generate a modified utterance text (or a modified utterance text set). For example, the reference utterance count may be set differently for each domain. In a case of a domain having a large number of collected training utterance texts, the reference utterance count may be set to be relatively great. In a case of a domain having a small number of collected training utterance texts, the reference utterance count may be set to be relatively small.

According to various embodiments, the intelligence server 200 may generate a modified utterance text based on a user feature extracted from the user utterance data. Alternatively, the intelligence server 200 may extract a user utterance pattern based on the user feature. When the number of user utterance patterns is greater than the reference pattern count, the intelligence server 200 may generate a modified utterance text based on the user utterance pattern. The reference pattern count may be determined based on an utterance quantity of the user utterance pattern or the number of parameters included in the user utterance pattern. For example, the user feature may include an age, a region, and a gender.

According to various embodiments, the intelligence server 200 may generate user utterance classification information based on user utterance data and may generate a modified utterance text based on the user utterance classification information. For example, the user utterance classification information may include domain information, intent information, and parameter information of user utterances included in the user utterance data.

According to various embodiments, the intelligence server 200 may cancel noise from the user utterance data, may extract a patterned sample pattern from the user utterance data, and may remove a user utterance, which is not semantically associated with a training utterance text (or a training utterance text set) from the user utterance data.

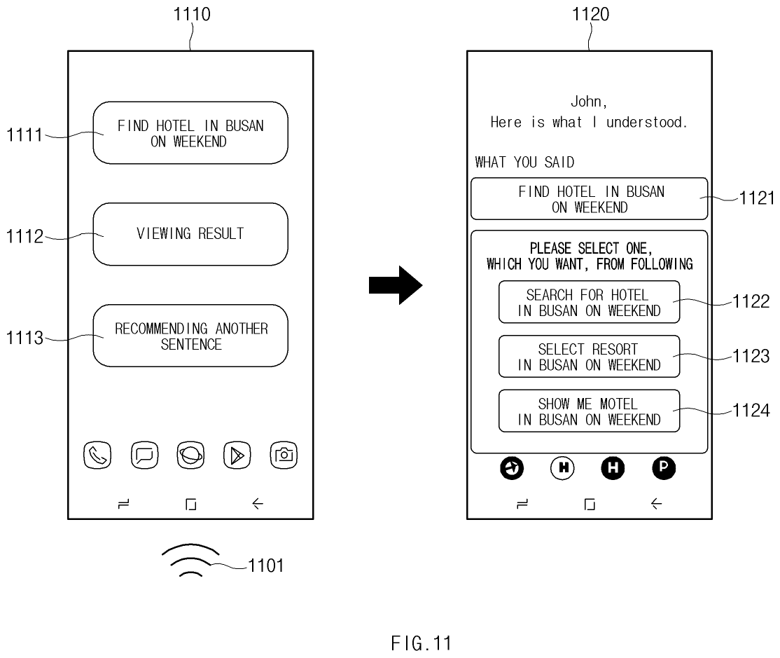

FIG. 11 is a diagram illustrating a method of recommending a modified utterance text to a user during a user utterance, according to an embodiment.

Referring to FIG. 11, a user terminal (e.g., the user terminal 100 of FIG. 4) may receive a user utterance 1101 and then may provide a modified utterance text similar to the user utterance 1101.

According to an embodiment, the user terminal may convert the user utterance 1101 into an utterance text 1111 and then may display the utterance text 1111 on a first screen 1110. The user terminal may display a result view item 1112 on the first screen 1110. When a user selects the result view item 1112, the user terminal may display the result (e.g., the execution of a path rule corresponding to the utterance text 1111) found based on the utterance text 1111, on a display.

According to an embodiment, when the user selects a modified utterance recommendation item 1113, the user terminal may display a second screen 1120. The user terminal may display an utterance text 1121 corresponding to the user utterance 1101 on the second screen 1120, and may display a modified utterance text 1122, 1123, or 1124 based on the utterance text 1121. The user terminal may transmit a user input (e.g., voice data) corresponding to the user utterance 1101 to an intelligence server (e.g., the intelligence server 200 in FIG. 4). The intelligence server may transmit a modified utterance text set corresponding to the received user input to the user terminal. The modified utterance text set may be pre-generated and stored or may be newly generated based on the received user input. The modified utterance text set may be generated by the methods described in FIGS. 4 to 8.

As described above, according to various embodiments, when the user utterance 1101 is entered, the user terminal may provide the modified utterance recommendation item 1113. When the user selects the modified utterance recommendation item 1113, the user terminal may provide the modified utterance text 1122, 1123, or 1124. Accordingly, the user terminal may provide an utterance text similar to a user utterance pattern. For example, the user terminal may recommend an utterance text (e.g., “turn off the phone”) similar to a user utterance pattern (familiar with the user) for a user utterance (e.g., “hang up the phone”), not a representative utterance (e.g., “end the phone”).

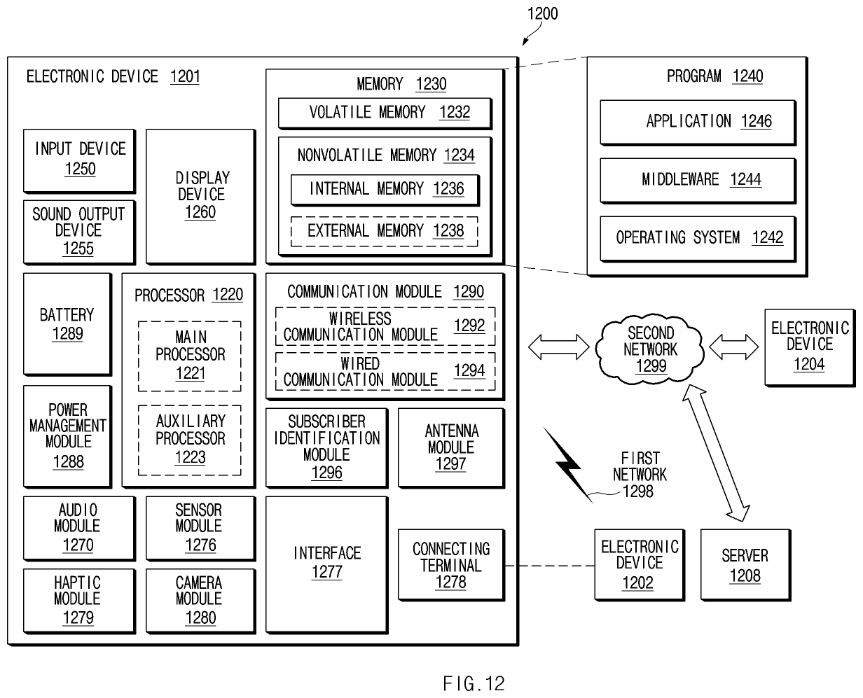

FIG. 12 is a block diagram illustrating an electronic device 1201 in a network environment 1200 according to various embodiments. Referring to FIG. 12, the electronic device 1201 (e.g., the user terminal 100) in the network environment 1200 may communicate with an electronic device 1202 via a first network 1298 (e.g., a short-range wireless communication), or an electronic device 1204 or a server 1208 (e.g., the intelligence server 200) via a second network 1299 (e.g., a long-range wireless communication network). According to an embodiment, the electronic device 1201 may communicate with the electronic device 1204 via the server 1208. According to an embodiment, the electronic device 1201 may include a processor 1220 (e.g., the processor 160), memory 1230 (e.g., the memory 150), an input device 1250 (e.g., the microphone 120), a sound output device 1255 (e.g., the speaker 130), a display device 1260 (e.g., the display 140), an audio module 1270, a sensor module 1276, an interface 1277, a haptic module 1279, a camera module 1280, a power management module 1288, a battery 1289, a communication module 1290, a subscriber identification module (SIM) 1296, or an antenna module 1297. In some embodiments, at least one (e.g., the display device 1260 or the camera module 1280) of the components may be omitted from the electronic device 1201, or other components may be added in the electronic device 1201. In some embodiments, some of the components may be implemented as single integrated circuitry. For example, the sensor module 1276 (e.g., a fingerprint sensor, an iris sensor, or an illuminance sensor) may be implemented as embedded in the display device 1260 (e.g., a display).

The processor 1220 may execute, for example, software (e.g., a program 1240) to control at least one other component (e.g., a hardware or software component) of the electronic device 1201 coupled with the processor 1220, and may perform various data processing and computation. The processor 1220 may load and process a command or data received from another component (e.g., the sensor module 1276 or the communication module 1290) in volatile memory 1232, and store resulting data in non-volatile memory 1234. According to an embodiment, the processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or to be specific to a specified function. Herein, the auxiliary processor 1223 may be operated separately from the main processor 1221 or embedded in the main processor 1921.

In this case, the auxiliary processor 1223 may control at least some of functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part component of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input device 1250 may receive a command or data to be used by other component (e.g., the processor 1220) of the electronic device 1201, from the outside (e.g., a user) of the electronic device 1201. The input device 1250 may include, for example, a microphone, a mouse, or a keyboard.

The sound output device 1255 may be a device for outputting a sound signal to the outside of the electronic device 1201; for example, the sound output device 1255 may include a speaker used for general purposes, such as multimedia playback or recording playback, and a receiver used only for receiving a call. According to an embodiment, the receiver may be implemented separately from the speaker or may be integrated with the speaker.

The display device 1260 may visually provide information to a user of the electronic device 1201. The display device 1260 may include, for example, a display, a hologram device, or a projector and control circuitry to control a corresponding one of the display, hologram device, and projector. According to an embodiment, the display device 1260 may include touch circuitry, or a pressure sensor to be able to measure the intensity of a pressure by a touch.

The audio module 1270 may convert a sound into an electrical signal and vice versa. According to an embodiment, the audio module 1270 may obtain the sound via the input device 1250, or output the sound via the sound output device 1255 or a headphone of an external electronic device (e.g., an electronic device 1202) directly (e.g., wiredly) or wirelessly coupled with the electronic device 1201.

The sensor module 1276 may generate an electrical signal or data value corresponding to an operational state (e.g., power or temperature) internal of the electronic device 1201 or an environmental state external to the electronic device 1201. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support a specified protocol to be coupled with the external electronic device (e.g., the electronic device 1202) wiredly or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. The haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a wired communication channel or a wireless communication channel between the electronic device 1201 and the external electronic device (e.g., the electronic device 1202, the electronic device 1204, or the server 1208) and performing communication via the established communication channel The communication module 1290 may include one or more communication processors that are operable independently from the processor 1220 (e.g., the application processor (AP)) and supports a wired communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a cellular network, the Internet, or a computer network (e.g., LAN or wide area network (WAN)). The above-mentioned various communication modules 1290 may be implemented into one chip or into separate chips, respectively.

According to an embodiment, the wireless communication module 1292 may distinguish and authenticate the electronic device 1201 in the communication network, using user information stored in the subscriber identification module 1296.

The antenna module 1297 may include one or more antennas to transmit or receive the signal or power to or from an external source. According to an embodiment, the communication module 1290 (e.g., the wireless communication module 1292) may transmit or receive the signal to or from the external electronic device through the antenna suitable for the communication method.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. According to an embodiment, all or some of operations to be executed at the electronic device 1201 may be executed at one or more of the external electronic devices. According to an embodiment, if the electronic device 1201 should perform a function or a service automatically, or by a request, the electronic device 1201, instead of, or in addition to, executing the function or the service, may request an external electronic device to perform at least a part function associated with the function or the service. The external electronic devices receiving the request may perform the function requested, or an additional function, and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, and/or replacements for a corresponding embodiment. With regard to the description of the drawings, similar reference numerals may be used to refer to similar elements. It is to be understood that a singular form of a noun corresponding to an item may include one or more of the things, unless the relevant context clearly indicates otherwise. As used herein, each of such phrases as “A or B”, “at least one of A and/or B”, “A, B, or C”, or “at least one of A, B, and/or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., a computer). For example, a processor(e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An operation method of an electronic device that communicates with a server, the method comprising:
receiving a domain and a category;
transmitting the domain and the category to the server;
receiving a modified utterance text corresponding to the domain and the category from the server; and
displaying the modified utterance text,
wherein the modified utterance text is generated through a generation model or a transfer learning model based on user utterance data stored in advance in the server, and
wherein the server is configured to:
convert voice data, which is delivered to the server by an external electronic device receiving a user utterance, into a text, and
store the text as the user utterance data.

2. The method of claim 1,
wherein the generation model includes generative adversarial networks (GAN), a variational autoencoder (VAE), and a deep neural network (DNN), and
wherein the transfer learning model includes a style-transfer.

3. The method of claim 1, wherein the server is configured to:
set the domain as a first domain;
determine a second domain having an utterance pattern similar to an utterance pattern in the first domain within the category; and
generate the modified utterance text based on the utterance pattern in the second domain.

4. The method of claim 3, wherein the server is configured to:
determine a domain, in which intent similar to intent used in the first domain is used, as the second domain.

5. The method of claim 1, wherein the server is configured to:
generate the modified utterance text based on a user feature extracted from the user utterance data.

6. The method of claim 5, wherein the server is configured to:
extract a user utterance pattern based on the user feature; and
when a count of the user utterance pattern is greater than a reference pattern count, generate the modified utterance text based on the user utterance pattern.

7. The method of claim 6, wherein the reference pattern count is determined based on an utterance quantity of the user utterance pattern and the number of parameters included in the user utterance pattern.

8. The method of claim 5, wherein the user feature includes an age, a region, and a gender.

9. The method of claim 1,
wherein the server is configured to:
generate user utterance classification information based on the user utterance data, and
generate the modified utterance text based on the user utterance classification information, and
wherein the user utterance classification information includes domain information of user utterances, intent information of user utterances, and parameter information of user utterances included in the user utterance data.

10. An operation method of an electronic device that communicates with a server, the method comprising:
receiving a domain and a category;
receiving a training utterance text set corresponding to the domain and the category;
transmitting the domain, the category, and the training utterance text set to the server;
receiving a modified utterance text set corresponding to the training utterance text set from the server; and
displaying the modified utterance text set,
wherein the modified utterance text set is generated through a generation model or a transfer learning model based on user utterance data stored in advance in the server, and
wherein the server is configured to:
convert voice data, which is delivered to the server by an external electronic device receiving a user utterance, into a text, and
store the text as the user utterance data.

11. The method of claim 10, wherein the server is configured to:
cancel noise from the user utterance data;
extract a patterned sample pattern from the user utterance data; and
remove a user utterance, which is not semantically associated with the training utterance text set, from the user utterance data.

12. The method of claim 10, wherein the server is configured to:
set the domain as a first domain;
determine a second domain having an utterance pattern similar to an utterance pattern in the first domain within the category; and
generate the modified utterance text set based on the utterance pattern in the second domain.

13. The method of claim 12, wherein the server is configured to:
determine intent of a training utterance text included in the training utterance text set; and
determine a domain, in which intent similar to the intent of the training utterance text is used, as the second domain.

14. The method of claim 12, wherein the server is configured to:
determine parameters included in the training utterance text set; and
generate the modified utterance text set by using parameters in the second domain similar to the parameters included in the training utterance text set.

15. The method of claim 10, wherein the server is configured to:
when the number of training utterance texts included in the training utterance text set is less than a reference utterance count, generate the modified utterance text set.
